(19) United States
(12) Patent Application Publication
(10) Pub. No.: US 2005/0251994 A1
(43) Pub. Date: Nov. 17, 2005

(54) Method for manufacturing nonradiative dielectric waveguide and nonradiative dielectric waveguide

(76) Inventor: Mitsuhiro Yuasa, Tokyo (JP)

Correspondence Address: Crowell & Moring, PO Box 14300, Washington, DC, 20044-4300, US

(21) Appl. No.: 10/524,294

(22) PCT Filed: Aug. 13, 2003
(86) PCT No.: PCT/JP03/10316

§ 371 Date: Feb. 11, 2005

(30) Foreign Application Priority Data
Aug. 14, 2002 (JP) 2002-236351

(51) Int. Cl. H01P 3/00

(52) U.S. Cl. 29/600; 333/239; 333/248

(57) ABSTRACT

A conductive film is formed on a substrate into which a MEMS circuit is fabricated, and a film of a dielectric A having a low dielectric constant and a film of a dielectric B having a high dielectric constant are formed on the conductive film, followed by the formation of a conductive film over the dielectric films. A millimeter wave is guided along the film of the dielectric B functioning as a dielectric waveguide, and is propagated along its length while being reflected by the conductors.

### TECHNICAL FIELD

The present invention relates to a transmission waveguide for transmitting millimeter or submillimeter waves therethrough and a method for fabricating such a transmission waveguide, and more particularly to a nonradiative dielectric waveguide and a method for fabricating the nonradiative dielectric waveguide.

### BACKGROUND ART

Rapid advances in information communication technology in recent years have been driving the need for transmission means that can transmit large volumes of information at high speed, and technologies that utilize millimeter or submillimeter waves are seen as promising technologies for application, for example, to wireless broadband networks. Among others, nonradiative dielectric waveguides and radiofrequency MEMSs (Micro Electro Mechanical Systems) are attracting attention as millimeter-wave-related technologies.

The nonradiative dielectric waveguide (hereinafter referred to as “the NRD guide”) was developed to overcome the shortcoming of the conventional dielectric waveguide which is a low-loss transmission line but has the problem that radiation occurs at a bend or a discontinuity in the transmission line. The NRD guide is a transmission line suitable for applications in the millimeter or submillimeter wave regions, since it suppresses unwanted radiation while retaining the low-loss characteristic of the conventional dielectric waveguide.

On the other hand, the radiofrequency MEMSs uses MEMS or micromachining technology, and various kinds of circuits for radiofrequency applications, resistors, capacitors, coils, switches, etc., are formed on a substrate using a micromachining process, and the radiofrequency MEMS devices or circuits thus constructed have good device characteristics and offer many advantages in terms of mounting.

However, in the prior art, the dielectric waveguide as a transmission line and two metal plates that sandwich the dielectric guide have been combined as separate parts to fabricate the NRD guide, and therefore, the prior art NRD guide has not been well suited for use in combination with a radiofrequency MEMS circuit.

### SUMMARY OF THE INVENTION

In view of the above problem, it is an object of the present invention to provide a fabrication method for a nonradiative dielectric waveguide which forms the NRD guide on a substrate by using a semiconductor process, and a nonradiative dielectric waveguide fabricated by such a fabrication method.

To achieve the above object, according to the present invention, a nonradiative dielectric waveguide is fabricated by: forming a conductive film on a substrate; forming a first dielectric film on the conductive film; forming a groove for a transmission line passing through the first dielectric film; embedding into this groove a second dielectric having a dielectric constant larger than that of the first dielectric film; and forming a conductive film on the dielectric films.

Further, according to the present invention, of the above fabrication steps, the step of embedding the second dielectric into the first dielectric film may be replaced by the step of first forming on the conductive film the second dielectric having a dielectric constant larger than that of the first dielectric film, then etching the second dielectric film to form a transmission line, and thereafter embedding the first dielectric film in the area where the second dielectric film has been etched away.

In a preferred mode of the invention, the nonradiative dielectric waveguide is fabricated by: forming a first sacrificial film on the conductive film formed on the substrate; forming a groove passing through the first sacrificial film and embedding a dielectric into the groove to form a transmission line; forming a second sacrificial layer thereon and etching away the second sacrificial layer everywhere except a plurality of portions thereof; forming a conductive film in the area where the second sacrificial layer has been etched away; and thereafter etching away the sacrificial layers.

In another preferred mode of the invention, the nonradiative dielectric waveguide is fabricated by: forming a first dielectric film on the substrate; forming a groove for a transmission line to such a depth that does not pass through the first dielectric film; embedding into this groove a second dielectric having a dielectric constant larger than that of the first dielectric film; forming another first dielectric film thereon; forming two grooves down to the substrate in such a manner as to cut off both edges of the second dielectric; and embedding a conductor into each of the two grooves.

A MEMS circuit may be fabricated into the substrate of the present invention.

A nonradiative dielectric waveguide according to the present invention comprises: a first conductive film formed on a substrate; a first dielectric film formed on top thereof; a second dielectric film surrounded by the first dielectric film and having a dielectric constant larger than that of the first dielectric film; and a second conductive film formed on top thereof.

Further, a nonradiative dielectric waveguide according to the present invention comprises: a pair of conductors formed vertically on a substrate; a pair of first dielectric films formed between the conductors; and a second dielectric film flanked by the first dielectric films and having a dielectric constant larger than that of the first dielectric film.

According to the fabrication method for the nonradiative dielectric waveguide of the present invention, the NRD guide can be fabricated using a semiconductor process, making it easy to combine the NRD guide with a MEMS circuit and thus offering a wide range of applications.

According to the present invention, an NRD guide can be fabricated that is easy to use in combination with a MEMS device.

Further, in the case of the NRD guide having the structure in which a dielectric is used instead of the air layer used in the conventional NRD guide, the NRD guide can be easily fabricated using a semiconductor process, and obtain a robust structure.

The present invention can also offer a fabrication process that can fabricate an NRD guide having an accurately controlled dielectric thickness.

### BRIEF DESCRIPTION OF THE DRAWINGS

FIG. 1 is a diagram showing the step of forming a first conductive film according to a first embodiment;

FIG. 2 is a diagram showing the step of forming a first dielectric-A film according to the first embodiment;

FIG. 3 is a diagram showing the step of etching the first dielectric-A film according to the first embodiment;

FIG. 4 is a diagram showing the step of embedding and planarizing a second dielectric-B film according to the first embodiment;

FIG. 5 is a diagram showing the step of forming a second conductive film according to the first embodiment;

FIG. 6 is a diagram showing the step of forming a passivation film according to the first embodiment;

FIG. 7 is a diagram showing the step of forming the second dielectric-B film according to a second embodiment;

FIG. 8 is a diagram showing the step of etching the second dielectric-B film according to the second embodiment;

FIG. 9 is a diagram showing the step of embedding and planarizing the first dielectric-A film according to the second embodiment;

FIG. 10 is a diagram showing the step of forming a sacrificial layer according to a third embodiment;

FIG. 11 is a diagram showing the step of etching the sacrificial layer according to the third embodiment;

FIG. 12 is a diagram showing the step of embedding and planarizing the dielectric B according to the third embodiment;

FIG. 13 is a diagram showing the step of forming a sacrificial layer according to the third embodiment;

FIG. 14 is a diagram showing the step of etching the sacrificial layer according to the third embodiment;

FIG. 15 is a diagram showing the step of forming and planarizing a conductive film according to the third embodiment;

FIG. 16 is a diagram showing the step of etching the sacrificial layers according to the third embodiment;

FIG. 17 is a diagram showing the step of forming the first dielectric-A film according to a fourth embodiment;

FIG. 18 is a diagram showing the step of etching the first dielectric-A film according to the fourth embodiment;

FIG. 19 is a diagram showing the step of forming and planarizing the second dielectric-B film according to the fourth embodiment;

FIG. 20 is a diagram showing the step of forming the first dielectric-A film according to the fourth embodiment;

FIG. 21 is a diagram showing the step of self-aligned etching according to the fourth embodiment;

FIG. 22 is a diagram showing the step of embedding and planarizing conductors according to the fourth embodiment;

FIG. 23 is a diagram showing the step of forming a passivation film according to the fourth embodiment; and

FIG. 24 is a schematic cross-sectional view for explaining an NRD guide.

### DETAILED DESCRIPTION OF THE INVENTION

First, an NRD guide will be explained.

FIG. 24 is a conceptual cross-sectional view for explaining an NRD guide. The NRD guide is constructed by sandwiching a dielectric D between conductive plates M such as metal or the like. When the gap d between the conductive plates M is made smaller than, for example, one-half the wavelength of the millimeter wave to be transmitted, the air region is in a cut-off state, so that the millimeter wave cannot exist there. However, inside the dielectric D, the cut-off state does not exist, since the wavelength decreases in the dielectric. Accordingly, when the dielectric D is used as a millimeter wave transmission line, the millimeter wave to be transmitted does not radiate into the surrounding space, and thus a dielectric waveguide can be achieved that has low loss and that eliminates unwanted radiation. Here, the transmitted wave is a surface wave that travels along the surface of the dielectric D, and is propagated along its length while being reflected by the conductive plates M.

Let the wavelength of the millimeter wave be denoted by λ, the gap between the conductive plates M by d, and the dielectric constant of the dielectric D by εr; then, when the gap d between the metal plates satisfies the relation
d<λ/2
the millimeter wave cannot be propagated through the air, but if the relation
d>λ/(2\sqrt{εr})
is satisfied inside the dielectric D, the millimeter wave can be propagated through the dielectric D whose dielectric constant is εr, thus achieving an NRD guide for the millimeter wave of wavelength λ.

For example, consider a millimeter wave of wavelength 2 mm, and assume that the dielectric constant εr of the dielectric D is 100 and the gap d between the conductive plates M is 0.5 mm; then
in the air, 2/2=1>d
in the dielectric, 2/(2·10)=0.1<d
   Therefore, the millimeter wave of wavelength 2 mm can be transmitted without unwanted radiation along the length of the transmission line formed from the dielectric D having a dielectric constant of 100.

A fabrication method for an NRD guide according to the present invention will be described below with reference to the drawings.

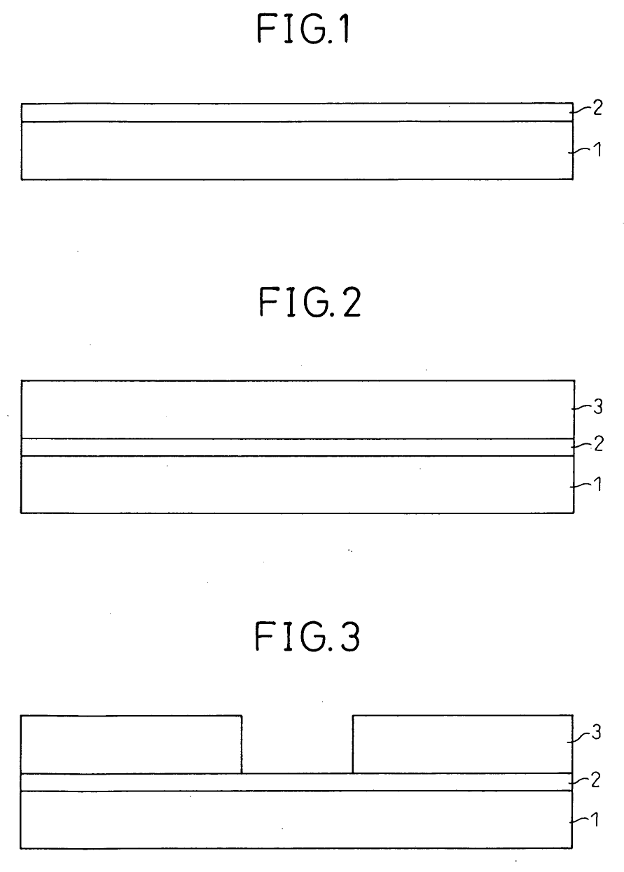

FIGS. 1 to 6 show a fabrication method according to a first embodiment of the present invention.

FIG. 1 is a diagram showing the step of forming a conductive film 2 made of a metal such as copper or aluminum on a substrate 1. In this embodiment, the substrate 1 contains a MEMS circuit constructed by forming various circuit elements, such as resistors, capacitors, coils, and switching elements, on a silicon wafer. However, in applications where only the transmission line is needed, a silicon wafer that does not include such a MEMS circuit should be used as the substrate 1. The conductive film 2 is formed by sputtering, plating, or another suitable technique. A known semiconductor process can be used for the formation of the film; for example, a barrier film of titanium or titanium nitride is deposited, and then a thin film is deposited by PVD (Physical Vapor Deposition) of Cu, after which electrolytic plating is performed to complete the formation of the film.

FIG. 2 shows the step of forming a film 3 of a dielectric A on the conductive film 2. The dielectric A is a material, such as SiO2 or SiOF, that has a relatively low dielectric constant.

FIG. 3 shows the process of etching the dielectric-A film 3. A groove into which a transmission line is to be embedded is formed by etching through the dielectric-A film 3.

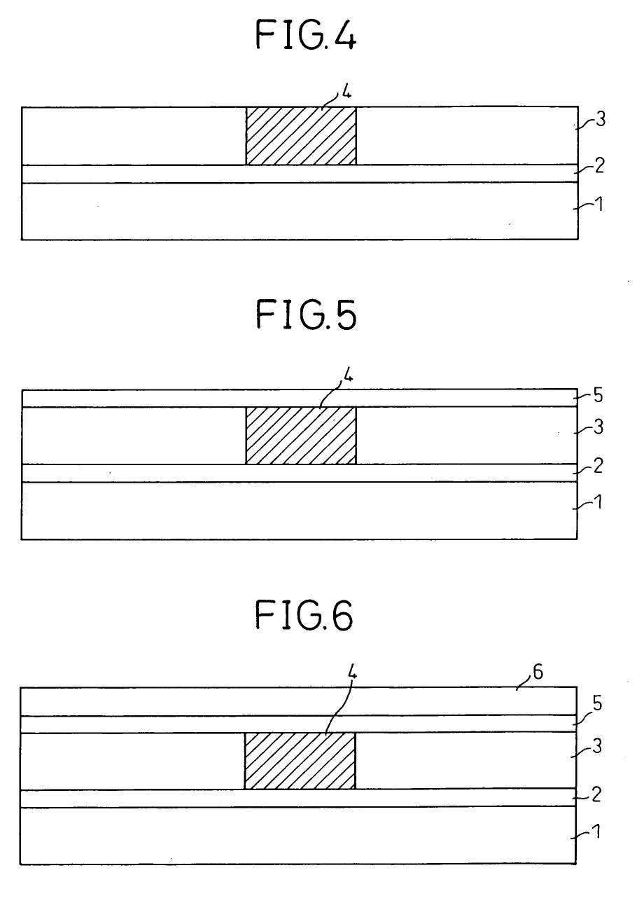

FIG. 4 shows the step of embedding a dielectric B, whose dielectric constant is larger than that of the dielectric A, into the etched groove after the etching step of FIG. 3. The dielectric B, which is, for example, a ceramic-based material, is embedded by spin coating and then planarized by CMP (Chemical Mechanical Polishing). The resulting film 4 of the dielectric B functions as a transmission line for transmitting a millimeter or submillimeter wave therethrough.

FIG. 5 shows the step of forming a conductive film 5 similar to that shown in FIG. 1.

Thereafter, a passivation film 6 is formed in the passivation step of FIG. 6. This completes the fabrication of the NRD guide in which the dielectric-B film 4 surrounding by the dielectric-A film 3 and sandwiched by the conductive films 2 and 5 functions as the transmission line. In this embodiment, the portion in which an air layer is formed in a conventional NRD guide is filled with the dielectric-A film 3. The dielectric-B film 4 is formed using a material having a larger dielectric constant than that of the dielectric-A film 3; if the dielectric constant difference is made large, a wave having any wavelength in the millimeter to submillimeter wave regions can be transmitted.

Since the dielectric-A film 3 is used in place of the air layer, this embodiment is appropriate to the semiconductor process, is easy to fabricate, and is robust as a NRD guide.

### Second Embodiment

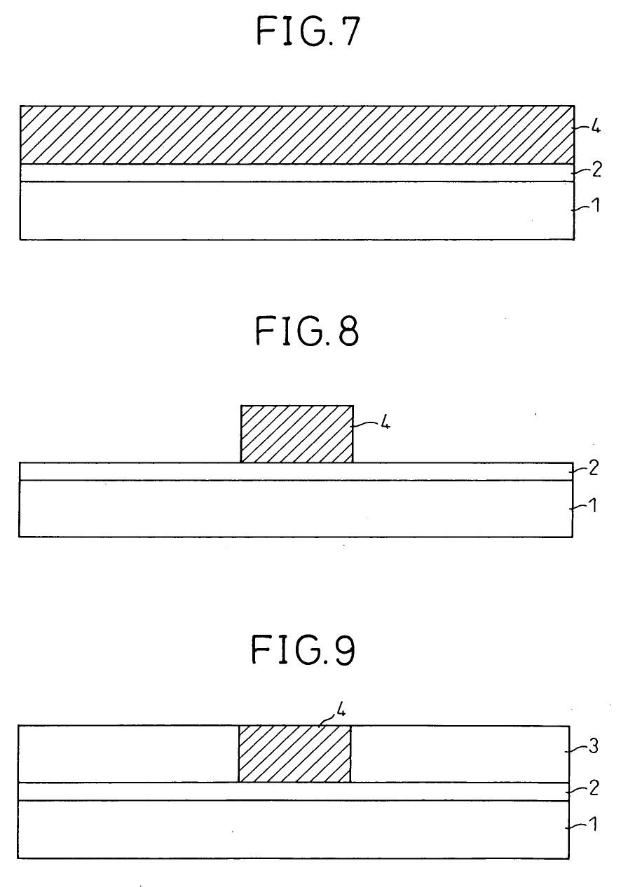

FIGS. 7 to 9 show a modified example of the dielectric film formation process (FIGS. 2 to 4) of the first embodiment for the NRD guide of the present invention.

In the second embodiment, first the dielectric-B film 4 is formed, as shown in FIG. 7, after forming the conductive layer 2 on the substrate 1. Next, as shown in FIG. 8, the dielectric-B film 4 is removed everywhere except the portion thereof necessary for the formation of the transmission line. After that, the dielectric A is embedded as shown in FIG. 9, and the surface is planarized. As earlier noted, the dielectric constant of the dielectric B is larger than that of the dielectric A.

This process also produces the dielectric-A film 3 and the dielectric-B film 4 of the same structure as that formed on the conductive layer 2 by the dielectric film formation process of the first embodiment (see FIG. 4). After the above step, a conductive layer is formed over the dielectric-A film 3 and the dielectric-B film 4, and a passivation film is formed on top thereof, as in the steps explained in the first embodiment.

### Third Embodiment

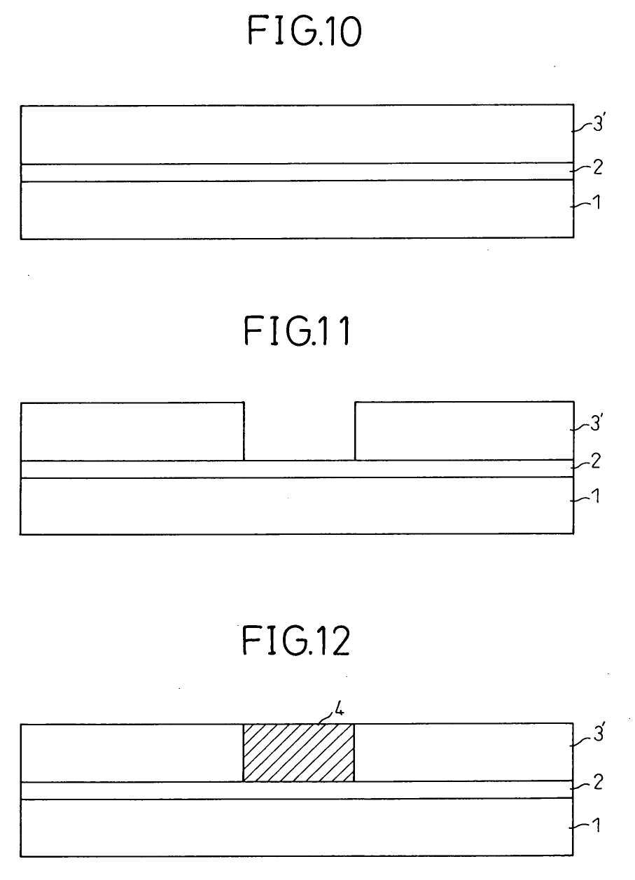

FIGS. 10 to 16 show a fabrication method according to the third embodiment of the present invention.

This embodiment concerns a fabrication method for constructing an NRD guide having a similar structure to that of a conventional NRD guide that does not have the dielectric A described above.

As shown in FIG. 10, a conductive film 2 is formed on a substrate 1 into which a MEMS circuit is fabricated as needed, and a sacrificial layer 3′ made, for example, of SiO2 is formed over the conductive film 2. A sacrificial layer is a layer that is removed in the final step.

Next, as shown in FIG. 11, the sacrificial layer 3′ is etched to form a groove passing therethrough, and as shown in FIG. 12, the dielectric B is embedded into this groove, and the surface is planarized.

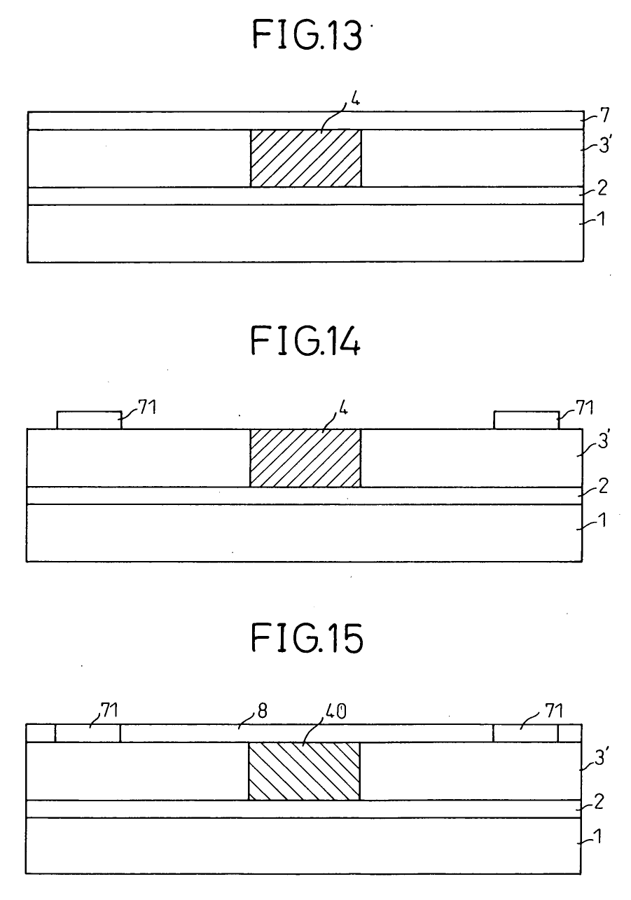

Then, as shown in FIG. 13, a sacrificial layer 7 made, for example, of SiO2, similar to the sacrificial layer 3′, is formed over the sacrificial layer 3′ and the dielectric-B film 4.

In the step shown in FIG. 14, the sacrificial layer 7 is etched off, leaving only protrusions 71. The protrusions 71 will be removed later to form holes for removal of the sacrificial layer 3′.

In FIG. 15, a conductive film 8 made of a metal such as Cu or Al is formed in the etched area and planarized.

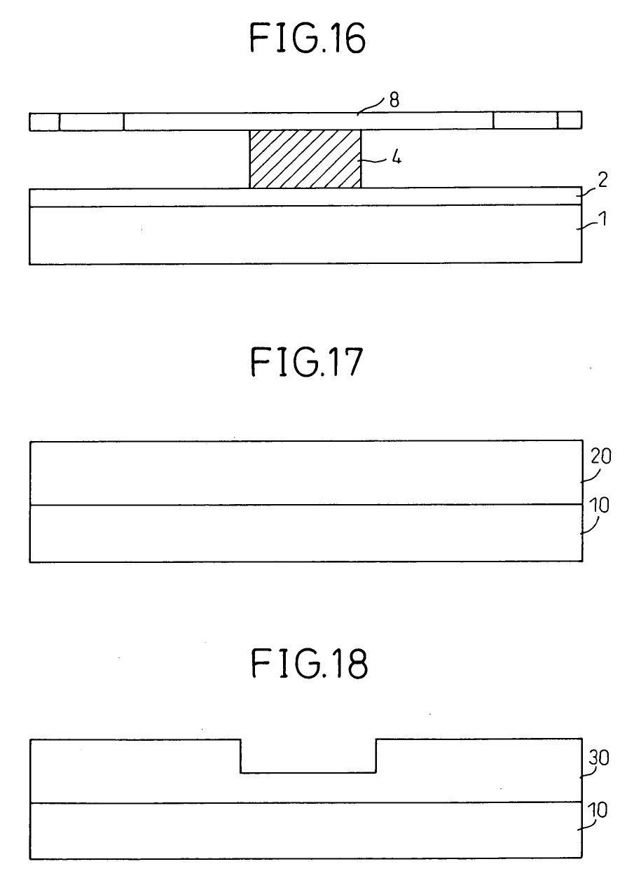

After that, the protrusions 71 of the sacrificial layer and the sacrificial layer 3′ are etched away as shown in FIG. 16. If the sacrificial layers are formed of SiO2, the sacrificial layers are etched using an HF or like solution; in this case, the process of etching proceeds through the sacrificial layer 71 and the sacrificial layer 3′ is completely removed.

As a result, the space surrounding the dielectric-B film 4 is filled with air, thus forming an NRD guide having a similar structure to that of the conventional NRD guide, that is, an NRD guide in which the dielectric B as the transmission line is surrounded by empty space and is sandwiched by the conductors 2 and 8.

The difference in dielectric constant between the dielectric B and the surrounding air in this embodiment is larger than the difference in dielectric constant between the dielectric B and the dielectric A in the first and second embodiments. Accordingly, the NRD guide of this embodiment has the feature of wider selection of the dielectric material.

### Fourth Embodiment

In the first to third embodiments, the thickness of the dielectric layer forming the transmission line is determined in the dielectric film formation step. The fourth embodiment is advantageous when the dielectric film thickness of the desired accuracy cannot be obtained in the film formation step.

As shown in FIG. 17, a dielectric-A film 30 is formed on a substrate 10 into which a MEMS circuit is fabricated as needed.

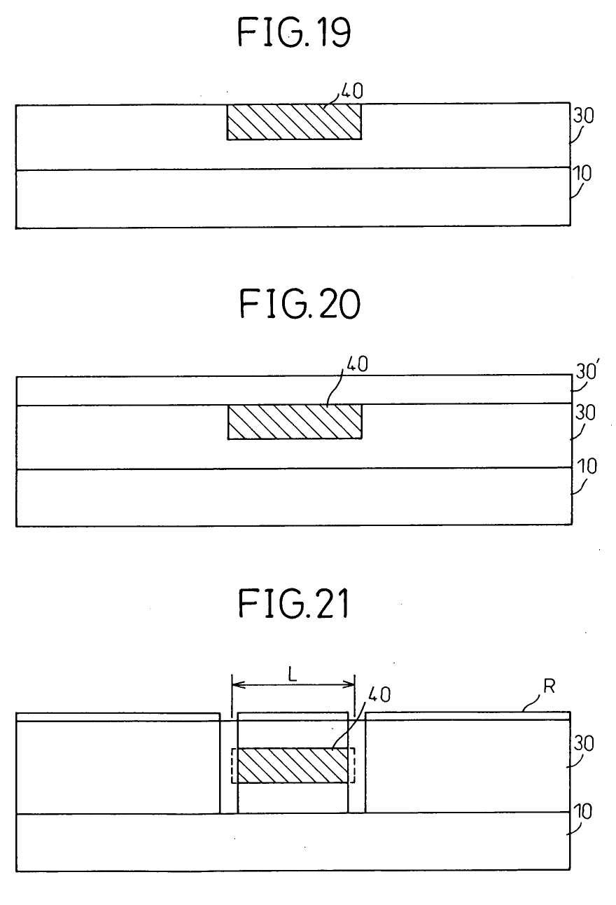

Next, as shown in FIG. 18, the dielectric-A film 30 is etched to form a groove for the transmission line. The groove is formed to be such a depth that does not pass through the dielectric-A film 30. Then, as shown in FIG. 19, a dielectric-B film 40, whose dielectric constant is larger than that of the dielectric A, is embedded into the groove, and the surface is planarized.

As shown in FIG. 20, another dielectric-A film 30′ is formed over the dielectric-A film 30 and the dielectric-B film 40.

Next, in FIG. 21, self-aligned etching is performed in order to accurately determine the width of the dielectric B that functions as the transmission line. In FIG. 21, the dielectric-A films 30 and 30′ together are shown as being the dielectric-A film 30 because the dielectric-A film 30′, when formed, becomes integral with the dielectric-A film 30.

A resist layer R is formed on the dielectric-A film 30, and the width of the dielectric 2 is determined so that it becomes smaller than the original length L of the dielectric 40, that is, in such a manner as to cut off both edges thereof. By using lithography, such a width can be accurately defined; thus, the width of the dielectric B that functions as the transmission line can be determined accurately. After that, etching is performed to remove the resist film R together with the dielectric-A film 30 and the dielectric-B film 40, thus forming grooves as shown in FIG. 21.

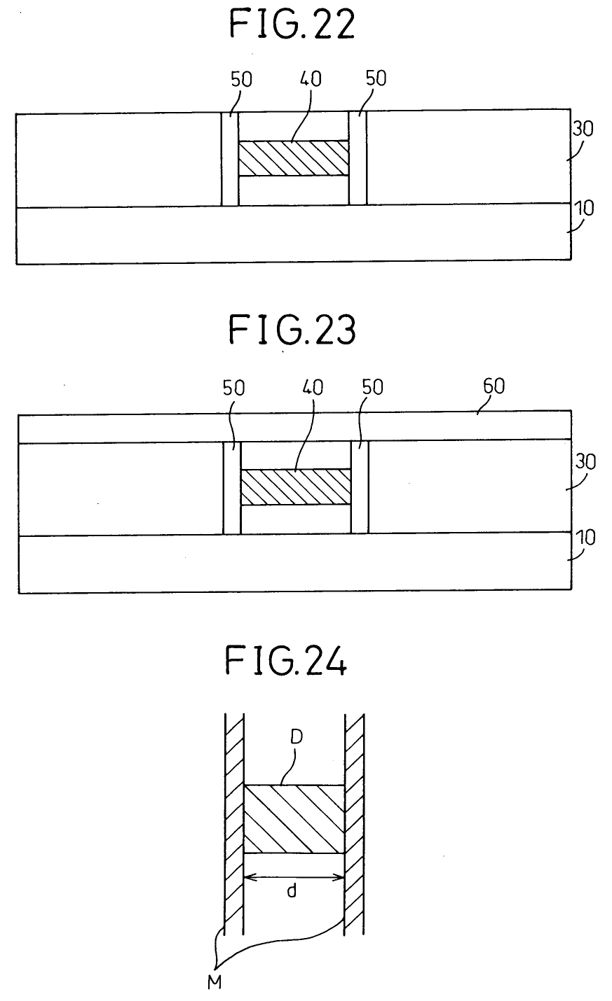

In the step shown in FIG. 22, conductors 50 of metal or the like are embedded into the respective grooves, and the surface is planarized, and in FIG. 23, a passivation film 60 is formed.

This process produces an NRD guide having the dielectric waveguide 40 having accurate dimensions and sandwiched by the metal conductors 50.

According to the embodiment, the thickness of the dielectric sandwiched by the conductors can be accurately determined, and thus an NRD guide having the desired characteristics can be fabricated.

1. (canceled)

2. (canceled)

3. A method for fabricating a nonradiative dielectric waveguide, comprising the steps of:
forming a first conductive film on a substrate;
forming on said first conductive film a second dielectric film whose dielectric constant is larger than that of a first dielectric film;
etching said second dielectric film to form a transmission line;
embedding said first dielectric film in an area where said second dielectric film has been etched away; and
forming a second conductive film on said first dielectric film and said second dielectric film.

4. A method for fabricating a nonradiative dielectric waveguide as claimed in claim 3, wherein a MEMS circuit is fabricated into said substrate.

5. A method for fabricating a nonradiative dielectric waveguide, comprising the steps of:
forming a conductive film on a substrate;
forming a first sacrificial film on said conductive film;
forming a groove for a transmission line passing through said first sacrificial film;
embedding a dielectric into said groove formed passing through said first sacrificial film;
forming a second sacrificial layer on said first sacrificial layer into which said dielectric has been embedded, and etching away said second sacrificial layer everywhere except a plurality of portions thereof;
forming a conductive film in an area where said second sacrificial layer has been etched away; and
etching away said first and second sacrificial layers.

6. A method for fabricating a nonradiative dielectric waveguide as claimed in claim 5, wherein a MEMS circuit is fabricated into said substrate.

7. A method for fabricating a nonradiative dielectric waveguide, comprising the steps of:
forming a first dielectric film on a substrate;
forming a groove for a transmission line to such a depth that does not pass through said first dielectric film;
embedding a second dielectric, whose dielectric constant is larger than that of said first dielectric film, into said groove formed in said first dielectric film;
forming another first dielectric film on said first dielectric film and said second dielectric film;
forming two grooves one spaced apart from the other by a distance smaller than the width of said second dielectric, said grooves being formed down to said substrate in such a manner as to cut off both edges of said second dielectric; and
embedding a conductor into each of said two grooves.

8. A method for fabricating a nonradiative dielectric waveguide as claimed in claim 7, wherein a MEMS circuit is fabricated into said substrate.

9. (canceled)

10. (canceled)

11. (canceled)

12. (canceled)
